(19) United States
(12) Patent Application Publication
(10) Pub. No.: US 2011/0256261 A1
(43) Pub. Date: Oct. 20, 2011

(54) RESISTANT FOOD STARCHES AND METHODS RELATED THERETO

(76) Inventors: Jay-lin Jane, Ames, IA (US); Jovin Hasjim, Ames, IA (US); Diane Birt, Ames, IA (US); Yinsheng Zhao, Ames, IA (US)

(21) Appl. No.: 12/672,918

(22) PCT Filed: Aug. 11, 2008
(86) PCT No.: PCT/US08/09576

§ 371 Date: Mar. 3, 2010

Related U.S. Application Data
(60) Provisional application No. 60/955,049, filed on Aug. 10, 2007.

(51) Int. Cl. A23L 1/0522

(52) U.S. Cl. 426/2; 426/661; 426/64; 426/48

(57) ABSTRACT

The present invention provides novel resistant starches, methods to make the resistant starches, and methods to use the resistant starches. These resistant starches may be used as an ingredient in a variety of foods to impart health benefits, such as: decreasing plasma insulin response; decreasing plasma glucose response; increasing colonic fermentation; decreasing the risk of colon cancer; increasing digestive health; decreasing colonic pH. The methods for making the novel modified resistant starches dramatically decrease the cost of producing them.

### REFERENCE TO PRIOR APPLICATIONS

The present invention claims priority to U.S. provisional patent application Ser. No. 60/955,049, filed on Aug. 10, 2007.

### FIELD OF THE INVENTION

The invention is in the fields of: food ingredients, particularly functional food ingredients such as digestion-resistant starches; food processing methods, particularly improved efficiencies in food starch manufacturing; and methods relating to improving health in mammals, particularly methods to reduce the negative effects of excess blood sugar, and methods to increase the positive effects of pre-biotic substances.

### BACKGROUND OF THE INVENTION

Resistant starch is defined as starch that cannot be completely digested and absorbed in the small intestine. Some types of resistant starches have been shown to reduce calorie intake, moderate blood glucose levels, reduce triglyceride levels and improve colon health by increasing beneficial bacterial counts. Some resistant starches therefore also have been classified as “prebiotics,” along with soluble and insoluble fibers. Although exact modalities are unknown, some resistant starches are known to function such that little or no digestion/absorption/fermentation commences until the molecules reach the colon. Sajilata, et al., “Comprehensive Reviews in Food Science and Food Safety” (2006) provides a review of resistant starch research.

In the past, commercial processing of resistant starch has been energy intensive, requiring high heat for long periods of time, with an additional cooling or freezing step. U.S. Pat. No. 5,051,271 provides an example of such processes. The resultant starches are relatively expensive compared to other blood sugar-lowering and prebiotic foods, with some known to lose their resistant nature when used as an ingredient in a baked item. A need exists for improvements in processing and functionality of resistant starches.

### SUMMARY OF THE INVENTION

The present processes are less time- and energy-consuming than those in the industry. The processes do not involve severe heating and cooling/freezing cycle; the total processing time is about two to four days, which is substantially shorter than other technologies. Moreover, the present processes can be accomplished on readily-available and multi-functional equipment.

The present starch material is granular and does not disperse to paste, which makes it inexpensive compared to other resistant starches in industrial applications. If further moisture reduction is desired, energy-saving centrifugation and/or filtration can be used. The inventive starch material contains well-above the resistant-starch content of other heat-stable products. Hence, they retain digestion resistance in the food products after heat processing. This novel technology produces low-cost resistant starch.

The present invention provides modified resistant starches comprising a starch complexed with lipid. Preferred are those resistant starches wherein the starch is selected from the group consisting of cornstarch; barley starch; potato starch; wheat starch; rice starch; bean starch; pea starch; root starch; legume starch; and grain-derived starch. Preferred starches for use in complexing with the lipid are those wherein the amylose content of the starch is greater than 20%, more preferably, greater than 30%, most preferably, greater than 40%. In particular, those modified resistant starches wherein the fatty acid is approximately 2 to 20% of the high amylose starch, when dry, and referenced by weight are provided. More preferred are those wherein the fatty acid is approximately 5 to 10%. Also provided are modified starches wherein the ratio of high amylose starch to fatty acid is from 5:1 to 50:1, preferably, those wherein the ratio is approximately 8:1 to 20:1.

Also provided are processes to produce the modified resistant starches herein, comprising: processing high amylose starch with lipid at a temperature with effects complexing, preferably in the range of approximately 60° C. to approximately 121° C., more preferably approximately 75° C. to approximately 90° C.; and subsequently drying the starch and lipid. The drying step can be any which effects the qualities desired, with active drying at approximately 25° C. to approximately 110° C. being preferred, and approximately 40° C. to 60° C. being more preferred. Preferred are those processes wherein the high-amylose starch is selected from the group consisting of: cornstarch; barley starch; potato starch; bean starch; legume starch; fruit starch; pea starch; root starch; wheat starch; rice starch; and grain starch. Preferred starches for use in complexing with the lipid are those wherein the amylose content of the starch is greater than 20%, more preferably, greater than 30%, most preferably, greater than 40%. Also preferred are those processes wherein the lipid is selected from the group consisting of: fatty acids; monoglycerides; diglycerides; and phospholipids. Preferred are those processes wherein the fatty acid is selected from the group consisting of: stearic acid; palmitic acid; myristic acid; butyric acid; oleic acid; and sodium propionate.

More preferred are those processes wherein the high-amylose starch has been pre-treated with a debranching enzyme, and the lipid is a fatty acid. Preferred are those processes wherein the pre-treating debranching enzyme is selected from the group consisting of: pullulanase and isoamylase.

Also provided are food compositions comprising a modified resistant starches herein.

Also provided are methods to affect the physiology of a mammal, selected from the group consisting of: decreasing plasma insulin response; decreasing plasma glucose response; increasing colonic fermentation; decreasing the risk of colon cancer; increasing digestive health; and decreasing colonic pH, comprising administering the resistant starches herein, preferably in food form.

### DEFINITIONS

“A” means one or more, as in “a fatty acid” means one or more types of fatty acids, and/or several molecules of fatty acid. “A resistant starch” means at least one molecule and/or at least one type of resistant starch. For instance “A modified resistant starch comprising a resistant starch and a lipid” could mean several molecules of resistant starch and several molecules of lipids, and it can also mean several different types of resistant starches and several different types of lipids. However, the previous statement can also mean one molecule of a certain type of resistant starch, complexed with one molecule of lipid.

### BRIEF DESCRIPTION OF THE DRAWINGS

FIG. 1 is a graph of the average increase in plasma glucose responses of 20 male subjects after consuming control white bread and enzyme-resistant bread.

FIG. 2 is a graph of the average increase in the plasma insulin responses of 20 male human subjects after consuming control white bread and enzyme-resistant bread.

### DETAILED DESCRIPTION

The starches used in preparing enzyme resistant starches may be any high-amylose starch derived from any native source. Also suitable are starches derived from a plant obtained by standard breeding techniques including crossbreeding, translocation, inversion, transformation or any other method of gene or chromosome engineering to include variations thereof. In addition, starch or derived from a plant grown from induced mutations and variations of the above generic composition which may be produced by known standard methods of mutation breeding are also suitable herein.

Many plants have starches that are ordinarily high in amylose, compared to mass-produced crops. For instance, starches of pea, bean, legumes and some fruits, such as banana, often possess over 35% amylose in their starch. It is for this reason that the present invention is not limited to the use of high-production crops, such as corn. Starches of some varieties of pea, bean, legumes and fruits may have sufficient amylose for use in the present invention.

Many plants have parts that are ordinarily high in amylose compared to mass-produced crops. For instance, pea, bean, legumes and root vegetables often possess over 30% amylose in the starch-producing plant part. It is for this reason that the present invention is not limited to the use of high-production crops. New varieties of pea, bean, legumes and roots may be developed to optimize amylose production and decrease processing costs, but the varieties now available contain sufficient amylose for use in the present invention, even without modification. The new and current varieties are within the scope of the invention.

The starch material useful in this invention also may include high amylose flour where the starch component of the flour contains at least 40% by weight of amylose. The term starch as used throughout this application is intended to include flour and when the high amylose content of flour is referred to throughout the application and claims, it is understood to refer to the amylose content of the starch component of the flour (e.g., 40% by weight of amylose based on the amount of starch in the flour). Such flour typically comprises protein (about 8 to 13% by weight), lipids (up to about 3% by weight) and starches (about 65 to 90% by weight) which include the specified high amylose content.

The resistant starch product of this invention may be used in any food or beverage product. Typical food products include, but are not limited to, baked goods such as breads, crackers, cookies, cakes, muffins, rolls, pastries and other grain-based ingredients; pasta; cereals such as ready-to-eat, puffed or expanded cereals and cereals which are cooked before eating; beverages; fried and coated foods; snacks; and cultured dairy products such as yogurts, cheeses, and sour creams.

The amount of resistant starch which can be added and used in any given food will be determined to a great extent by the amount that can be tolerated from a functional standpoint. In other words, the amount of resistant starch used generally will be as high as will be acceptable in organoleptic evaluation of the food. Generally the resistant starch may be used in food applications at about 0.1 to 50%, by weight of the food and more particularly from about 1 to 25% by weight.

The resistant starch of this invention may also be used in a pharmaceutical or nutritional product, including but not limited to prebiotic and synbiotic compositions, diabetic foods and supplements, dietetic foods, foods to control glycemic response, and tablets and other pharmaceutical dosage forms. A prebiotic composition is a nondigestible food ingredient that beneficially affects the host by selectively stimulating the growth, activity or both of one or a limited number of bacterial species already resident in the colon. A synbiotic composition may be a yogurt, capsule or other form of introduction into the host animal, including human beings, in which prebiotics are used in combination with a live microbial food supplement. The live microbial food supplement beneficially affects the host animal by improving its intestinal microbial balance. Such live microbial food supplements may include, without limit, yeasts such as Saccharoymyces, and bacteria such as the genera Bifobacterium, Bacteriodes, Clostridium, Fusobacterium, Propionibacterium, Streptococcus, Enterococcus, Lactococcus, Staphylococcus, Peptostreptococcus and Lactobacillus.

The resistant starches of the present invention can be also be used in low-fat margarine, snack dips, sour cream, mayonnaise, cream cheese and other spreads, yogurt, milkshakes, ice cream and frozen desserts. The resistant starches of the present invention are also suitable for inclusion in nutritional and dietary drinks, as well as in foods which are useful for the slow release of glucose, such as for diabetics. The resistant starch is also useful as a component of a stabilizer complex in frozen foods to control ice crystal formation. The resistant starch of the present invention can be used in sugar-free foods as well; the amount of sugar, flour or fat in a given formulation which can be replaced with the microcrystalline starch-based product will depend in part on the formulation, the desired properties of the food and the amount of calorie and/or fat reduction or fiber content desired. The product of the present invention can also be added as an extender to a formulation without reducing any of the other ingredients. The extended product has a lower calorie per volume compared with the unextended product.

For dough-based products, total amount of the flour component plus resistant starch used in the compositions of the present invention may range, for example, from about 20% by weight to about 80% by weight, preferably from about 45% by weight to about 75% by weight, based upon the weight of the dough. Unless otherwise indicated, all weight percentages are based upon the total weight of all ingredients forming the doughs or formulations of the present invention, except for inclusions such as flavor chips, nuts, raisins, and the like. Thus, “the weight of the dough” does not include the weight of inclusions.

The flour component may be replaced in whole or in part by conventional flour substitutes or bulking agents, such as polydextrose, hollocellulose, microcrystalline cellulose, mixtures thereof, and the like. Corn bran, wheat bran, oat bran, rice bran, mixtures thereof, and the like may also be substituted in whole or in part for the flour component to enhance color, or to affect texture.

Process-compatible ingredients, which can be used to modify the texture of the products produced in the present invention, include sugars such as sucrose, fructose, lactose, dextrose, galactose, maltodextrins, corn syrup solids, hydrogenated starch hydrolysates, protein hydrolysates, glucose syrup, mixtures thereof, and the like. Reducing sugars, such as fructose, maltose, lactose, and dextrose, or mixtures of reducing sugars may be used to promote browning.

Oleaginous compositions which may be used to obtain the doughs and baked goods of the present invention may include any known shortening or fat blends or compositions useful for baking applications, and they may include conventional food-grade emulsifiers. Vegetable oils, lard, marine oils, and mixtures thereof, which are fractionated, partially hydrogenated, and/or interesterified, are exemplary of the shortenings or fats which may be used in the present invention. Edible reduced- or low-calorie, partially digestible or non-digestible fats, fat-substitutes, or synthetic fats, such as sucrose polyesters or triacyl glycerides, which are process-compatible may also be used. Preferred oleaginous compositions for use in the present invention comprise soybean oil.

In addition to the foregoing, the doughs of the invention may include other additives conventionally employed in crackers and cookies. Such additives may include, for example, milk by-products, egg or egg by-products, cocoa, vanilla or other flavorings, as well as inclusions such as nuts, raisins, coconut, flavored chips such as chocolate chips, butterscotch chips and caramel chips, and the like in conventional amounts.

The dough compositions of the present invention may contain up to about 5% by weight of a leavening system, based upon the weight of the dough.

The doughs of the present invention may include antimycotics or preservatives, such as calcium propionate, potassium sorbate, sorbic acid, and the like. Exemplary amounts may range up to about 1% by weight of the dough, to assure microbial shelf-stability.

Emulsifiers may be included in effective, emulsifying amounts in the doughs of the present invention. Exemplary emulsifiers which may be used include, mono- and di-glycerides, polyoxyethylene sorbitan fatty acid esters, lecithin, stearoyl lactylates, and mixtures thereof. Exemplary amounts of the emulsifier which may be used range up to about 3% by weight of the dough.

Production of the doughs of the present invention may be performed using conventional dough mixing techniques and equipment used in the production of cookie and cracker doughs. For example, the doughs may be sheeted, wire cut, extruded, coextruded, or rotary molded using conventional equipment. The resistant starch ingredient is preferably preblended with the flour component to obtain a substantially homogeneous mixture for mixing with the other dough ingredients.

### EXAMPLES

### Example 1

### Materials Useful to Make or Analyze Resistant Starch

The following materials were gathered for use in producing and testing resistant starch formulations and processes. High amylose cornstarch VII starch (HA7, AmyloGel™ 03003) and normal cornstarch (NC) were gifts of Cargill, Hammond, Ind. Lecithin (LE, Ultralec®-P), diglycerides (DG, Enova™), and monoglycerides (MG3, Panalite® 90-03 K; MG70, Panalite® 90-70 K; MG130, Panalite® 90-130 K; the number represents the iodine value or the degree of unsaturation of monoglycerides) were gifts of ADM, Decatur, Ill. The following enzymes and reagents were purchased from Sigma-Aldrich Corp. (St. Louis, Mo.) and used as received: sodium propionate (NaPr, Cat. No. P1880), butyric acid (BA, Cat. No. B2503), myristic acid (MA, Cat. No. M3253), palmitic acid (PA, Cat. No. P0625 and Cat. No. W283207), stearic acid (SA, Cat. No. W303518), oleic acid (OA, Cat. No. 364525), heat-stable α-amylase from Bacillus licheniformis (Cat. No. A3403), protease from Bacillus licheniformis (Cat. No. P3910), glucoamylase from Aspergillus Niger (Cat. No. A9913), pullulanase from Bacillus acidopullulyticus (PUL, ≧400 units/mL, Cat. No. P2986), tris(hydroxylmethyl)aminomethane (Tris, Cat. No. T1503), 2-morpholinoethanesulfonic acid (MES, Cat. No. M3671), and celite (Cat. No. C8656). Technical grade isoamylase (ISO) from Pseudomonas amyloderamosa (62,000 units/mL) was a gift of Hayashibara Biochemical Laboratories, Inc. (Okayama, Japan).

### Example 2

### Methods Used to Analyze Resistant Starch Content and Protein Content of Food Samples Containing Resistant Starches

A. Enzymatic-Gravimetric Method (AOAC Method 991.43) for Determining Dietary Fiber (Resistant Starch) Content of a Sample.

A precisely weighed starch sample (1 g, dry starch basis, dsb) was suspended in a MES-Tris buffer solution (0.05M, pH 8.2, 40 mL). Heat-stable α-amylase (500U) was added to the suspension. The mixture was incubated in a boiling-water bath with stirring for 30 minutes. The enzyme digestate was then cooled and equilibrated in a water bath at 60° C. and incubated with protease (5.0 mg) at the same temperature for 30 minutes under agitation (120 rpm). The suspension was then adjusted to pH 4.4-4.6 by adding hydrochloric acid solution (0.561 M) and incubated with glucoamylase (300 μL) in the water bath at 60° C. for 30 minutes under agitation (120 rpm). The enzyme digestate was then cooled to room temperature and filtered through a tared coarse fitted glass crucible with a layer of celite (1.0 g) on the surface as the filter aid. The collected solid residue was washed twice with 15 mL of deionized water, twice with 15 mL of 78% ethanol, twice with 15 mL of absolute ethanol, and once with 15 mL of acetone. The crucible with sample was dried in a convection oven at 110° C.

% RS=dry weight of residue/dry weight of starch×100

B. Dumas Method for Analyzing Nitrogen Contents of Food Samples Made with Resistant Starches.

The nitrogen contents of the residues of vital wheat gluten and noodle samples after enzyme treatments following the AOAC method 991.43 were detected using Dumas method (RapidN III, Elementar Americas, Inc., Mt. Laurel, N.J.) following the procedure of Jung et al. (2003). The nitrogen content was converted to protein content by conversion factor of 5.33.

C. Macro-Kjedahl Method for Analyzing Nitrogen Contents of Food Samples Made with Resistant Starches.

The nitrogen contents of the residues of enriched bread flour, vital wheat gluten, and bread samples after enzyme treatments following the AOAC method 991.43 were analyzed using macro-Kjedahl method following the method of Jung et al. (2003). The residue from 1 g of enriched bread flour, vital wheat gluten, or bread sample was digested with 16 mL concentrated sulfuric acid in the presence of a mixture of catalyst containing CuSeO₃ and K₂SO₄ (Kjeldahl Digestion Mixture #600, Merck KGaA, Darmstadt, Germany) using a Büchi 435 Digestion Unit (Flawil, Switzerland). The distillation was carried out in an alkaline condition by adding NaOH (10N, 60 mL) to the sample in Büchi B-324 Distillation Unit (Flawil, Switzerland). The distilled ammonia was collected in a solution containing boric acid (4%) and pH indicator (0.375 g of methyl red and 0.250 g of methylene blue in 300 mL of 95% ethanol) was used to identify the end point of titration. The titration was carried out using standardized 0.1 N HCl. The nitrogen content was converted to protein content by conversion factor of 5.33.

### Example 3

### Preparing and Analyzing Novel Resistant Starches from HA7 and Fatty Acid—Heating at 80° C.

An aqueous suspension of AmyloGel™ 03003 (10% w/w) (“HA7”) was heated in a water bath at 80° C. for 30 minutes. Fatty acid (2-10% w/w, dsb) was added to the suspension with stirring. The starch-fatty acid mixture was heated in the water bath at 80° C. for additional 30 minutes. The mixture was then cooled to room temperature. The starch-fatty acid complex was recovered by centrifugation, washed with 50% ethanol, and dried in a convection oven at 50° C. to a moisture content of below 12% (w/w). The RS contents of the resulting products are shown in Table 1.

TABLE 1
The resistant starch contents of Example 1.

| Treatments¹ | Resistant starch² (%) |
|---|---|
| HA7 control | 36.7 ± 0.2 |
| HA7 + 10% PA | 58.3 ± 1.7 |
| HA7 + 10% SA | 59.8 ± 2.8 |

¹HA7 = AmyloGel ™ 03003 (high amylose cornstarch VII), PA = palmitic acid, SA = stearic acid, and percentage = weight percentage of fatty acid, dsb.
²Resistant starch content was analyzed using AOAC Method 991.43. Mean ± standard deviation from at least 2 replicates.

### Example 4

### Preparing and Analyzing Novel Resistant Starches from HA7 and Fatty Acid—Boiling Only

An aqueous suspension of AmyloGel™ 03003 (10% w/w) (“HA7”) was heated in a boiling-water bath for 30 minutes. Fatty acid (10% w/w, dsb) was added to the suspension with stirring. The starch-fatty acid mixture was heated in the boiling-water bath for additional 30 minutes. The mixture was then cooled to room temperature. The starch-fatty acid complex was recovered by centrifugation, washed with 50% ethanol, and dried in a convection oven at 50° C. to a moisture content of below 12% (w/w). The RS contents of the resulting products are shown in Table 2.

TABLE 2
The resistant starch contents of Example 2.

| Treatments¹ | Resistant starch² (%) |
|---|---|
| HA7 control | 34.7 ± 1.7 |
| HA7 + 2% PA | 35.7 ± 0.6 |
| HA7 + 3% PA | 34.2 ± 1.8 |
| HA7 + 5% PA | 36.9 ± 1.9 |
| HA7 + 10% PA | 42.0 ± 0.5 |
| HA7 + 10% SA | 44.4 ± 0.5 |
| HA7 + 5% DG | 36.8 ± 0.3 |
| HA7 + 10% DG | 37.2 ± 0.5 |
| HA7 + 5% LE | 37.4 ± 0.8 |

¹HA7 = AmyloGel ™ 03003 (high amylose cornstarch VII), PA = palmitic acid, SA = stearic acid, DG = diglycerides, LE = lecithin, and percentage = weight percentage of fatty acid, dsb.
²Resistant starch content was analyzed using AOAC Method 991.43. Mean ± standard deviation from at least 2 replicates.

### Example 5

### Preparing and Analyzing Novel Resistant Starches from HA7 and Fatty Acid—Boiling/Autoclave Method

An aqueous suspension of AmyloGel™ 03003 (10% w/w) was heated in a boiling-water bath for 30 minutes. Fatty acid (10% and 20% w/w, dsb) was added to the suspension with stirring. The mixture was autoclaved to 121° C. for 15 minutes and heated in the boiling-water bath for additional 30 minutes. The mixture was then cooled to room temperature. The starch-fatty acid complex was recovered by centrifugation, washed with 50% ethanol, and dried in a convection oven at 50° C. to a moisture content of below 12% (w/w). The RS contents of the resulting products are listed in Table 3.

TABLE 3
The resistant starch contents of Example 3.

| Treatments¹ | Resistant starch² (%) |
|---|---|
| HA7 control | 28.9 ± 1.8 |
| HA7 + 10% PA | 35.9 ± 1.4 |
| HA7 + 20% PA | 37.5 ± 1.7 |
| HA7 + 10% SA | 36.5 ± 2.3 |

¹HA7 = AmyloGel ™ 03003 (high amylose cornstarch VII), PA = palmitic acid, SA = stearic acid, and percentage = weight percentage of fatty acid, dsb.
²Resistant starch content was analyzed using AOAC method 991.43. Mean ± standard deviation of results obtained from at least 2 replicates.

### Example 6

### Preparing and Analyzing Novel Resistant Starches from HA7 and Fatty Acid—Isoamylase Treatment and Heating at 80° C.

An aqueous suspension of AmyloGel™ 03003 (10% w/w) (HA7) was heated in a water bath at 80° C. for 30 minutes and then cooled to room temperature. The suspension was adjusted to pH 3.5 by slowly adding hydrochloric acid solution (0.5 M). The starch suspension was incubated with isoamylase (0.4% v/w, dsb) in a water bath at 60° C. for 24 hours with agitation. Fatty acid (10% w/w, dsb) was added to the isoamylase-treated-starch suspension. The starch-fatty acid mixture was heated in the water bath at 80° C. for 30 minutes. The starch-fatty acid complex was then recovered by centrifugation, washed with distilled water and 50% ethanol, and dried in a convection oven at 50° C. to a moisture content of below 12% (w/w). The RS contents of resulting products are listed in Table 4.

TABLE 4
The resistant starch contents of Example 4.

| Treatments¹ | Resistant starch² (%) |
|---|---|
| HA7 control | 36.7 ± 0.2 |
| HA7 + 0.4% ISO + 10% PA | 74.3 ± 2.4 |
| HA7 + 0.4% ISO + 10% SA | 74.8 ± 1.5 |

¹HA7 = high amylose cornstarch VII, ISO = isoamylase, PA = palmitic acid, SA = stearic acid, and percentage = mL/g percentage of isoamylase, dsb, and weight percentage of fatty acid, dsb.
²Resistant starch content was analyzed using AOAC Method 991.43. Mean ± standard deviation from at least 2 replicates.

### Example 7

### Preparing and Analyzing Novel Resistant Starches from HA7 and Fatty Acid—Isoamylase Treatment & Boiling Only

An aqueous suspension of AmyloGel™ 03003 (5% w/w) (HA7) was heated in a boiling-water bath for 30 minutes and then cooled to room temperature. The suspension was adjusted to pH 3.5 by slowly adding hydrochloric acid solution (0.5 M). The starch suspension was incubated with isoamylase (0.4% and 0.8% v/w, dsb) in a water bath at 60° C. for 24 hours with agitation. Fatty acid (10% w/w, dsb) was added to the isoamylase-treated-starch suspension. The starch-fatty acid mixture was heated in the boiling-water bath for 30 minutes. The starch-fatty acid complex was then recovered by centrifugation, washed with distilled water and 50% ethanol, and dried in a convection oven at 50° C. to moisture content of below 12% (w/w). The RS contents of resulting products are listed in Table 5.

TABLE 5
The resistant starch contents of Example 5.

| Treatments¹ | Resistant starch² (%) |
|---|---|
| HA7 control | 34.7 ± 1.7 |
| HA7 + 0.4% ISO + 10% PA | 56.6 ± 1.5 |
| HA7 + 0.8% ISO + 10% PA | 55.8 ± 1.7 |
| HA7 + 0.4% ISO + 10% SA | 65.6 ± 2.0 |
| HA7 + 0.4% ISO + 10% MG3 | 46.4 ± 3.9 |
| HA7 + 0.4% ISO + 10% MG70 | 48.8 ± 2.5 |
| HA7 + 0.4% ISO + 10% MG130 | 41.0 ± 6.2 |

¹HA7 = AmyloGel ™ 03003 (high amylose cornstarch VII), ISO = isoamylase, PA = palmitic acid, SA = stearic acid, MG# = monoglycerides with specific iodine value, and percentage = v/w, dsb, percentage of isoamylase and w/w, dsb, percentage of fatty acid.
²Resistant starch content was analyzed using AOAC Method 991.43. Mean ± standard deviation from at least 2 replicates.

### Example 8

### Preparing and Analyzing Novel Resistant Starches from HA7 and Fatty Acid—Isoamylase Treatment and Boiling/Autoclave Method

An aqueous suspension of AmyloGel™ 03003 (5% w/w) (HA7) was heated in a boiling-water bath for 30 minutes, autoclaved at 121° C. for 15 minutes, and then cooled to room temperature. The suspension was adjusted to pH 3.5 by slowly adding hydrochloric acid solution (0.5 M). The starch suspension was incubated with isoamylase (0.4% v/w, dsb) in a water bath at 60° C. for 24 hours with agitation. Fatty acid (10% w/w, dsb) was added to the isoamylase-treated-starch suspension. The starch-fatty acid mixture was heated in the boiling-water bath for 30 minutes. The starch-fatty acid complex was then recovered by centrifugation, washed with distilled water and 50% ethanol, and dried in a convection oven at 50° C. to a moisture content of below 12% (w/w). The RS contents of resulting products are listed in Table 6.

TABLE 6
The resistant starch contents of Example 6.

| Treatments | Resistant starch²(%) |
|---|---|
| HA7 control | 28.9 ± 1.8 |
| HA7 + 0.4% ISO + 10% PA | 43.8 ± 1.3 |
| HA7 + 0.4% ISO + 10% SA | 51.3 ± 0.9 |

¹HA7 = high amylose cornstarch VII, ISO = isoamylase, PA = palmitic acid, SA = stearic acid, and percentage = mL/g percentage of isoamylase, dsb, and weight percentage of fatty acid, dsb.
²Resistant starch content was analyzed using AOAC Method 991.43. Mean ± standard deviation from at least 2 replicates.

### Example 9

### Preparing and Analyzing Novel Resistant Starches from HA7 and Fatty Acid—Pullulanase Treatment and Heating at 80° C.

An aqueous suspension of AmyloGel™ 03003 (10% w/w) (HA7) was heated in a water bath at 80° C. for 30 minutes and then cooled to room temperature. The suspension was adjusted to pH 5.0 by slowly adding hydrochloric acid solution (0.5 M). The starch suspension was incubated with pullulanase (0.125% to 5%, v/w, dsb) in a water bath at 60° C. for 24 hours to 72 hours with agitation. Fatty acid and fatty acid salt (5% to 10% w/w, dsb) was added to the pullulanase-treated-starch suspension. The starch-fatty acid mixture was heated in the water bath at 80° C. for 30 minutes. The starch-fatty acid complex was then recovered by centrifugation, washed with distilled water and 50% ethanol, and dried in a convection oven at 50° C. to a moisture content of below 12% (w/w). The RS contents of resulting products are listed in Table 7.

TABLE 7
The resistant starch contents of Example 7.

| Treatments¹ | Resistant starch² (%) |
|---|---|
| HA7 control | 36.7 ± 0.2 |
| HA7 + 1.25% PUL(24 hr) + 10% NaPr | 48.1 ± 2.9 |
| HA7 + 1.25% PUL(24 hr) + 10% BA | 44.8 ± 0.8 |
| HA7 + 1.25% PUL(24 hr) + 10% MA | 62.7 ± 3.0 |
| HA7 + 0.25% PUL(24 hr) + 10% PA | 60.9 ± 0.4 |
| HA7 + 0.50% PUL(24 hr) + 10% PA | 59.8 ± 0.8 |
| HA7 + 1.25% PUL(24 hr) + 10% PA | 69.9 ± 2.2 |
| HA7 + 5% PUL(24 hr) + 10% PA | 65.0 ± 0.9 |
| HA7 + 0.125% PUL(72 hr) + 5% SA | 72.2 ± 0.2 |
| HA7 + 0.125% PUL(72 hr) + 10% SA | 70.6 ± 1.1 |
| HA7 + 0.25% PUL(24 hr) + 5% SA | 59.4 ± 0.9 |
| HA7 + 0.25% PUL(72 hr) + 5% SA | 68.6 ± 1.7 |
| HA7 + 0.25% PUL(24 hr) + 10% SA | 61.8 ± 0.6 |
| HA7 + 1.25% PUL(24 hr) + 10% SA | 71.6 ± 0.3 |
| HA7 + 2.5% PUL(24 hr) + 10% SA | 77.0 ± 2.2 |
| HA7 + 5% PUL(24 hr) + 10% SA | 77.0 ± 2.1 |
| HA7 + 1.25% PUL(24 hr) + 10% OA | 63.2 ± 0.6 |

¹HA7 = high amylose cornstarch VII, PUL = pullulanase, NaPr = sodium propionate, BA = butyric acid, MA = myristic acid, PA = palmitic acid, SA = stearic acid, OA = oleic acid, ( ) = hours of treatment with pullulanase, and percentage = mL/g percentage of pullulanase, dsb, and weight percentage of fatty acid, dsb.
²Resistant starch content was analyzed using AOAC Method 991.43. Mean ± standard deviation from at least 2 replicates.

### Example 10

### Preparing and Analyzing Novel Resistant Starches from HA7 and Fatty Acid—Pullulanase Treatment and Boiling Only

An aqueous suspension of AmyloGel™ 03003 (5% w/w) (HA7) was heated in a boiling-water bath for 30 minutes and then cooled to room temperature. The suspension was adjusted to pH 5.0 by slowly adding hydrochloric acid solution (0.5 M). The starch suspension was incubated with pullulanase (1.25% and 5%, v/w, dsb) in a water bath at 60° C. for 24 hours with agitation. Fatty acid (10% w/w, dsb) was added to the pullulanase-treated-starch suspension. The starch-fatty acid mixture was heated in the boiling-water bath for 30 minutes. The starch-fatty acid complex was then recovered by centrifugation, washed with distilled water and 50% ethanol, and dried in a convection oven at 50° C. to a moisture content of below 12% (w/w). The RS contents of resulting products are listed in Table 8.

TABLE 8
The resistant starch contents of Example 8.

| Treatments¹ | Resistant starch² (%) |
|---|---|
| HA7 control | 34.7 ± 1.7 |
| HA7 + 1.25% PUL + 10% PA | 43.4 ± 2.8 |
| HA7 + 5% PUL + 10% PA | 52.5 ± 2.6 |
| HA7 + 1.25% PUL + 10% SA | 55.0 ± 0.9 |

¹HA7 = AmyloGel ™ 03003 (high amylose cornstarch VII), PUL = pullulanase, PA = palmitic acid, SA = stearic acid, and percentage = mL/g percentage of pullulanase, dsb, and weight percentage of fatty acid, dsb.
²Resistant starch content was analyzed using AOAC Method 991.43. Mean ± standard deviation from at least 2 replicates.

### Example 11

### Preparing and Analyzing Novel Resistant Starches from HA7 and Fatty Acid—Pullulanase Treatment and Boiling/Autoclave Method

An aqueous suspension of AmyloGel™ 03003 (5% w/w) (HA7) was heated in a boiling-water bath for 30 minutes, autoclaved at 121° C. for 15 minutes, and then cooled to room temperature. The suspension was adjusted to pH 5.0 by slowly adding hydrochloric acid solution (0.5 M). The starch suspension was incubated with pullulanase (1.25%, v/w, dsb) in a water bath at 60° C. for 24 hours with agitation. Fatty acid (10% w/w, dsb) was added to the pullulanase-treated-starch suspension. The starch-fatty acid mixture was heated in the boiling-water bath for 30 minutes. The starch-fatty acid complex was then recovered by centrifugation, washed with distilled water and 50% ethanol, and dried in a convection oven at 50° C. to a moisture content of below 12% (w/w). The RS contents of resulting products are listed in Table 9.

TABLE 9
The resistant starch contents of Example 9.

| Treatments¹ | Resistant starch² (%) |
|---|---|
| HA7 control | 28.9 ± 1.7 |
| HA7 + 1.25% PUL + 10% PA | 37.7 ± 3.3 |
| HA7 + 1.25% PUL + 10% SA | 44.6 ± 1.0 |

¹HA7 = high amylose cornstarch VII, PUL = pullulanase, PA = palmitic acid, SA = stearic acid, and percentage = mL/g percentage of pullulanase, dsb, and weight percentage of fatty acid, dsb.
²Resistant starch content was analyzed using AOAC Method 991.43. Mean ± standard deviation from at least 2 replicates.

### Example 12

### Preparing and Analyzing Novel Resistant Starches from Normal Cornstarch and Fatty Acid—Pullulanase Treatment

An aqueous suspension of normal cornstarch (5% w/w) was heated in a water bath at 60° C., 70° C., or 80° C. for 30 minutes and then cooled to room temperature. The suspension was adjusted to pH 5.0 by slowly adding hydrochloric acid solution (0.5 M). The starch suspension was incubated with pullulanase (1.25%, v/w, dsb) in a water bath at 60° C. for 24 hours with agitation. Fatty acid (10% w/w, dsb) was added to the pullulanase-treated-starch suspension. The starch-fatty acid mixture was heated in the water bath at the same temperature as the first heating (60° C., 70° C., or 80° C., respectively) for 30 minutes. The starch-fatty acid complex was then recovered by centrifugation, washed with distilled water and 50% ethanol, and dried in a convection oven at 50° C. to a moisture content of below 12% (w/w). The RS contents of resulting products are listed in Table 10.

TABLE 10
The resistant starch contents of Example 10.

| Treatments¹ | Resistant starch² (%) |
|---|---|
| Native NC control | 1.58 ± 1.32 |
| NC + 1.25% PUL + 10% PA (60° C.) | 8.32 |
| NC + 1.25% PUL + 10% PA (70° C.) | 6.71 ± 1.76 |
| NC + 1.25% PUL + 10% PA (80° C.) | 3.80 ± 2.03 |
| NC + 1.25% PUL + 10% SA (60° C.) | 2.47 ± 1.00 |
| NC + 1.25% PUL + 10% SA (70° C.) | 5.37 ± 0.19 |
| NC + 1.25% PUL + 10% SA (80° C.) | 7.59 ± 1.43 |

¹NC = normal cornstarch, PUL = pullulanase, PA = palmitic acid, SA = stearic acid, ( ) = processing temperature, and percentage = mL/g percentage of pullulanase, dsb, and weight percentage of fatty acid, dsb.
²Resistant starch content was analyzed using AOAC Method 991.43. Mean ± standard deviation from at least 2 replicates.

### Example 13

### Industrial Scale Production of Resistant Starches—Pilot Plant

In the pilot plant, the HA7 starch-palmitic acid complex samples were produced by heating an aqueous suspension of HA7 (10% w/w) in a steam jacketed kettle (Model TDB/7-40, Groen, Jackson, Miss.) for 1 hour at 90° C.-95° C. with agitation. Palmitic acid (Cat. No. W28320-7, 4% and 10% w/w, dsb) was added to the suspension in the kettle. The suspension was heated for additional 30 minutes, cooled down, centrifuged, washed with 50% ethanol, and air-dried.

The debranching-enzyme-treated-HA7-fatty acid complex samples were produced by heating an aqueous suspension of HA7 (7% w/w) in a steam jacketed kettle for 1 hour at 80° C.-95° C. with agitation and then cooled to 55° C. The suspension was adjusted to pH 3.5 and 5.0 for isoamylase and pullulanase hydrolysis, respectively. The starch suspension was treated with isoamylase (0.8%, v/w, dsb) for 12 hours in the kettle at 55° C.-60° C. with agitation or pullulanase (1.25% v/w, dsb) for 24 hours at 50° C.-55° C. in a hot-water-jacketed stainless steel tank (Model 70 gallon JOVC, Viatec™, Belding, Mich.) with agitation. Fatty acid (10% w/w, dsb) was added to the debranching-enzyme-treated-HA7 suspension. The HA7 starch-fatty acid mixture was heated back at 80° C.-95° C. for additional 1 hour and stored in refrigerator overnight. The HA7 starch-fatty acid complex samples were then recovered by centrifugation, washed with 50% ethanol, and dried in a convection oven at 50° C. to moisture content of below 12%. All samples prepared in the pilot plant were ground using Magic Mill III Plus (Magic Mill, Monsey, N.Y.). The resistant starch contents of the samples prepared in the pilot plant are listed in Table 11.

TABLE 11
The resistant starch contents of Example 11.

| Treatment¹ | Resistant starch²(%) |
|---|---|
| HA7 + 4% PA³ | 41.3 ± 2.2 |
| HA7 + 10% PA³ | 39.2 ± 1.9 |
| HA7 + 0.8% ISO(12 hr) + 10% PA⁴ | 52.7 ± 1.5 |
| HA7 + 1.25% PUL(24 hr) + 10% PA⁵ | 64.8 ± 0.3 |
| HA7 + 1.25% PUL(24 hr) + 10% SA⁵ | 66.4 ± 1.3 |

¹HA7 = high amylose cornstarch VII, ISO = isoamylase, PUL = pullulanase, PA = palmitic acid, SA = stearic acid, ( ) = hours of treatment with debranching enzyme, and percentage = mL/g percentage of pullulanase or weight percentage of fatty acid, dsb.
²Resistant starch content was analyzed using AOAC Method 991.43. Mean ± standard deviation from at least 2 replicates.
³The samples were prepared at 90-95° C. and air-dried at room temperature.
⁴The sample was prepared at 90-95° C. and dried in a convection oven at 50° C. to a moisture content of below 12%.
⁵The sample was prepared at ~80° C. and dried in a convection oven at 50° C. to a moisture content of below 12%.

### Example 14

### Preparation and Analysis of Noodles Made with Resistant Starches

The ground starch-lipid complex was mixed with boiling water in a 1 to 1 ratio to form dough. The dough was rolled with a rolling pin to form a thin sheet, which was then cut into thin slices and air-dried. The dried noodle was kept in the refrigerator until needed. Vital wheat gluten was also incorporated in the noodle to bind the noodle together and to decrease the dispersion during boiling.

TABLE 12
The resistant starch contents of cooked high amylose
cornstarch VII-palmitic acid complex noodles.

| | Initial | | |
|---|---|---|---|
| | Protein | Undigested | Resistant |
| | Content | Protein² | Starch³ |
| Treatments¹ | (%) | (%) | (%) |
| HA7 + 4% PA starch | 0 | 0 | 41.3 ± 2.2 |
| VWG | 100 | 7.9 | 0 |
| HA7 + 4% PA noodle | 0 | 0 | 38.7 ± 2.0 |
| HA7 + 4% PA + 16% VWG | 16 | 19.7 | 41.6 ± 1.2 |
| noodle | | | |

¹HA7 = 70% high-amylose cornstarch, PA = palmitic acid, VWG = vital wheat gluten, and percentage = weight percentage of palmitic acid, dsb, and w/w percentage of vital wheat gluten on the basis of dry HA7 + 4% PA starch. Noodle samples were boiled in water before enzyme treatments following the AOAC Method 991.43.
²Percentage of undigested protein from initial total protein weight analyzed using Dumas method.
³Resistant starch content (excluding the undigested protein content) was analyzed using AOAC Method 991.43. Mean ± standard deviation from at least 2 replicates.

### Example 15

### Preparation and Analysis of Bread from Resistant Starches

For control bread, enriched bread flour (600 g) was mixed with melted soft spread (25 g, 52% fat), salt solution (4 g in 130 g water), and yeast dispersion (5 g in 100 g of warm water) using Kitchen Aid® Stand Mixer (St. Joseph, Mich.) with a ‘C’ dough hook at mixing speed of 2 for 3.5 minutes. The bread dough was allowed to rise in a greased pan for one hour and then in a greased loaf pan (9.5×5.25×2.625 in³) for an additional hour. The dough was baked in a conventional oven at 400° F. for 25 minutes. The bread loaf was cooled at room temperature for 1 hour before storing it in a sealed zip lock bag. For enzyme-resistant bread, 75% of enriched bread flour (450 g) was substituted with resistant starch (HA7+0.8% ISO(12 hr)+10% PA) (398 g), which contained 52.7% enzyme resistance, and vital wheat gluten (78 g), whereas other ingredients were kept the same. The resistant starch contents of the bread samples are listed in Table 13. Table 14 lists the composition of control white bread and enzyme-resistant bread.

TABLE 13
Percentages of total residue, undigested protein,
and resistant starch content of bread samples.

| | Total | | |
|---|---|---|---|
| | undigested | Undigested | Resistant |
| Samples | residue¹(%) | protein² (%) | starch³ (%) |
| Enriched Bread Flour | 4.8 ± 0.1 | 2.7 ± 0.2 | 2.1 |
| HA7 + 0.8% ISO(12 hr) + | 52.7 ± 1.5 | 0 | 52.7 |
| 10% PA starch⁴ | | | |
| vital wheat gluten | 45.2 ± 1.6 | 34.2 ± 1.0 | 11.0 |
| Control White Bread⁵ | 6.5 ± 0.8 | 3.2 ± 0.2 | 3.3 |
| Enzyme-Resistant Bread⁶ | 37.4 ± 3.5 | 3.1 ± 0.4 | 34.4 |

¹Total undigested residue was analyzed using AOAC method 991.43. Mean ± standard deviation from duplicates.
²Undigested protein was analyzed using macro-Kjeldahl method on the solid residue from the digestion according to the AOAC method 991.43.
³Resistant starch = total undigested residue − undigested protein
⁴HA7 + 0.8% ISO(12 hr) + 10 PA starch with 52.7 resistant starch content was prepared in the pilot plant as described in Example 11.
⁵Control white bread contained 96% enriched bread flour
⁶Enzyme-resistant bread contained 24% enriched bread flour, 60% debranched HA7-PA complex, and 12% vital wheat gluten.

TABLE 14
The compositions of control white bread and enzyme-resistant bread.

| Ingredients | Control White Bread | | | | | | Enzyme-Resistant Bread | | | | | |
|---|---|---|---|---|---|---|---|---|---|---|---|---|
| Weight (g) | Total | Starch | Protein | Moisture | Others | RS^{a} | Total | Starch | Protein | Moisture | Other | RS |
| Flour | 600 | 476 | 84 | 40 | 0 | 12 | 150 | 119 | 21 | 10 | 0 | 3 |
| Debranched | 0 | 0 | 0 | 0 | 0 | 0 | 398 | 352 | 0 | 46 | 0 | 185 |
| HA7-PA | | | | | | | | | | | | |
| complex^{b} | | | | | | | | | | | | |
| Vital Wheat | 0 | 0 | 0 | 0 | 0 | 0 | 78 | 6 | 63 | 7 | 2 | 8 |
| Gluten | | | | | | | | | | | | |
| Soft spread | 25 | 0 | 0 | 12 | 13 | 0 | 25 | 0 | 0 | 12 | 13 | 0 |
| Yeast | 5 | 0 | 0 | 0 | 5 | 0 | 5 | 0 | 0 | 0 | 5 | 0 |
| Salt | 4 | 0 | 0 | 0 | 4 | 0 | 4 | 0 | 0 | 0 | 4 | 0 |
| Water | 330 | 0 | 0 | 330 | 0 | 0 | 590 | 0 | 0 | 590 | 0 | 0 |
| Total | 964 | 476 | 84 | 382 | 22 | 12 | 1250 | 477 | 84 | 665 | 24 | 196 |
| weight | | | | | | | | | | | | |
| Percentage^{c} | 100% | 82% | 14% | — | 4% | 2% | 100% | 82% | 14% | — | 4% | 34% |

^{a}Resistant starch content was analyzed using AOAC Method 991.43. Mean ± standard deviation from at least 2 replicates. Resistant starch was included in the starch content.
^{b}HA7 + 0.8% ISO(12 hr) + 10% PA with 52.7% RS content was prepared in the pilot plant as described in the methods.
^{c}Percentage of starch and protein on the dry basis of the whole ingredients.

### Example 16

### Analysis of Plasma Glucose and Plasma Insulin Concentrations in Humans Who Consumed Foods Made with the Present Resistant Starches

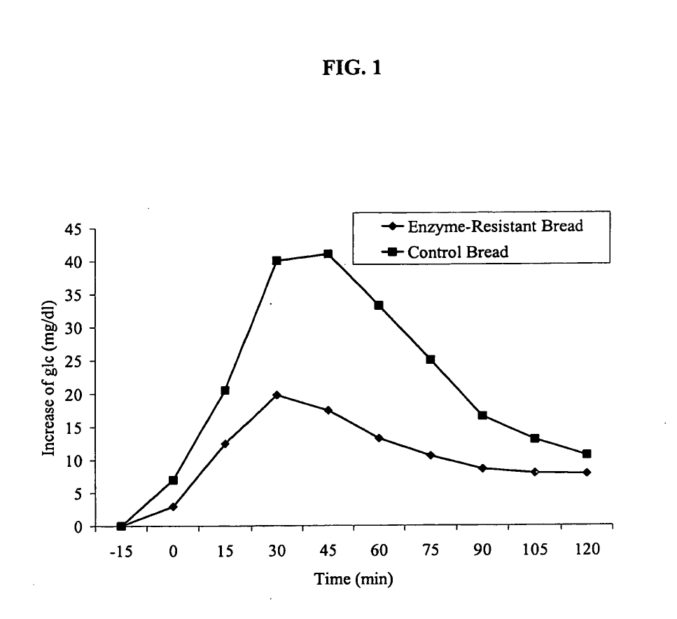

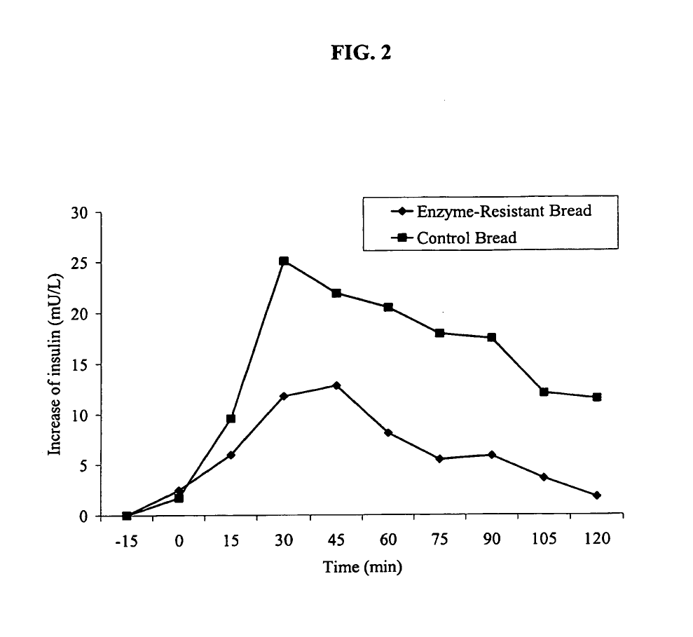

Twenty healthy male human subjects were recruited for plasma glucose and plasma insulin study. After an overnight fasting, each subject received a slice of test bread containing 50 g of starch each test day. All subjects ingested both the control white bread and enzyme-resistant bread on separate days. Blood samples were collected from the subjects every 15 minutes from 15 minutes before ingesting the test bread to 2 hours after ingesting the test bread. Plasma glucose and plasma insulin concentrations in the blood samples were analyzed by Dr. Suzanne Hendrich, Professor, and Dr. Sun-Ok Lee, Post-doctoral Research Associate, of the Department of Food Science and Human Nutrition, at Iowa State University, Ames, Iowa. The plasma glucose concentrations were measured using a glucose oxidase analyzer (Beckman Coulter Glucose Anlyzer, Beckman Coulter Inc., Fullerton, Calif.) and the plasma insulin concentrations were determined using an ultrasensitive insulin ELISA (Enzyme-Linked Immuno Sorbent Assay) kit (ALPCO diagnostics, Salem, N.H.). Results are expressed in FIG. 1 and FIG. 2.

### Example 17

### Comparison of Effects of 3 Starch Diets on the Occurrence of Pre-Neoplastic Lesion, Mucin Depleted Foci, Induced by the Chemical Carcinogen Azoxymethane (AOM) in F344 Rats, so as to Determine the Ability of Different Starch Diets to Prevent or Reduce Colon Cancer

Five-week-old, male F344 rats were ordered as the experimental animals. They were fed with control starch diet for two weeks. Subsequently, half of the rats were injected with AOM, once weekly for two weeks. The other rats were injected with saline, once weekly for two weeks. Control starch diet made from which contains 55% cooked normal cornstarch and other necessary rat diet nutrients, was fed during the AOM injection process. After the second AOM or saline injection, the rats were divided randomly but evenly into three diet groups. Three starch diets were fed to the groups for eight weeks. Each diet contained 55% cooked starch, together with 45% of other raw ingredients including protein, vitamin, mineral, amino acid, and fat etc that are necessary for rats' nutritive requirements.

The control group contained regular cooked starch, the second group (group 2) contained high amylose cooked cornstarch VII, and the third (group 3) contained high-amylose cornstarch VII which had been pre-treated with a pullulanase debranching enzyme (HA7+1.25% PUL(24 hr)+10% SA starch prepared in the pilot plant).

After eight weeks on the three diets, the rats were killed and colons were collected as microscope observable specimens to calculate ACF and MDF number. Other endpoints were also collected such as liver weight, cecum weight, and cecum pH. The end points were compared based on carcinogen or diet groups by the means of two-way ANOVA.

### Results

| | liver | cecum weight | cecum weight | cecum | average |
|---|---|---|---|---|---|
| | weight (g) | with content (g) | without content (g) | content pH | MDF |
| AOM, control | 7.9 ± 1.0 | 4.1 ± 0.3 | 0.8 ± 0.2 | 7.46 ± 0.09 | 3.5 ± 1.8 |
| starch | | | | | |
| AOM, group 2 | 7.8 ± 0.7 | 16.6 ± 3.0* | 3.0 ± 0.6* | 6.60 ± 0.58* | 1.8 ± 1.4* |
| AOM, group 3 | 7.1 ± 2.6 | 21.6 ± 1.2* | 2.9 ± 0.6* | 5.69 ± 0.15* | 0.3 ± 0.5* |
| Saline, control | 7.0 ± 1.1 | 4.3 ± 1.5 | 1.2 ± 0.3 | 7.39 ± 0.14 | 0 |
| starch | | | | | |
| Saline, group 2 | 7.6 ± 1.0 | 16.0 ± 3.0^{$} | 2.7 ± 0.5^{$} | 6.74 ± 0.36^{$} | 0 |
| Saline, group 3 | 8.6 ± 0.9 | 19.3 ± 2.5^{$} | 3.3 ± 0.7^{$} | 5.70 ± 0.33^{$} | 0 |

Values are means ± std. dev.
*P < 0.05 compared to AOM Control starch diet.
^{$}P < 0.05 compared to Saline Control starch diet.

The two-way ANOVA results showed that:

No significant differences were observed in body weight, food consumption, or liver weight. Cecal weight was significantly elevated by resistant starch diet and High amylose starch diet. Cecal pH was significantly decreased by resistant starch diet and High amylose starch diet. MDF was only seen with AOM and was reduced with Resistant starch diet and High amylose starch diet. Aberrant crypt foci (ACF) are the earliest, visually identifiable hyperplastic lesions considered to occur along the normal to carcinoma sequence of colorectal cancer progression in humans since their presence and numbers are highly correlated with the development of carcinomas. ACF are also used as pre-neoplastic lesions because they can be chemically induced in laboratory mammalian strains. Mucin-depleted foci (MDF) are a subset of ACF which are regarded as more highly correlated to carcinoma development than ACF, although their characterization is not currently as well established as ACF. ACF and MDF can be microscopically observed after staining with alcian blue and neutral red. AOM is a carcinogen that is selective for colon, with some reports of a few small bowel/stomach tumors. Pre-neoplastic lesions could be found 8-10 weeks after AOM injection.

What is claimed is:

1. A modified resistant starch comprising a starch complexed with lipid.

2. A resistant starch of claim 1, wherein the starch is selected from the group consisting of: cornstarch; barley starch; potato starch; wheat starch; rice starch; bean starch; legume starch; pea starch; fruit starch; root starch; and grain starch.

3. A resistant starch of claim 1, wherein the lipid is selected from the group consisting of: fatty acids; monoglycerides; diglycerides; and phospholipids.

4. A resistant starch of claim 1, wherein the lipid is a fatty acid.

5. A resistant starch of claim 4, wherein the fatty acid is selected from the group consisting of: stearic acid; palmitic acid; myristic acid; butyric acid; oleic acid; and sodium propionate.

6. A resistant starch of claim 1, wherein the high-amylose starch has been pre-treated with a debranching enzyme, and the lipid is a fatty acid.

7. A resistant starch of claim 6, wherein the debranching enzyme is selected from the group consisting of: pullulanase and isoamylase.

8. A resistant starch of claim 6, wherein the fatty acid is approximately 2 to 20% of the high amylose starch, when dry, and referenced by weight.

9. A resistant starch of claim 9, wherein the fatty acid is approximately 5 to 10%.

10. A process to produce a modified resistant starch, comprising: processing starch with lipid at a temperature in the range of approximately 60° C. to approximately 112° C.; and subsequently drying the starch and lipid at a temperature in the range of approximately 25° C. to approximately 110° C.

11. A process of claim 12, wherein the starch is selected from the group consisting of: cornstarch; barley starch; potato starch; wheat starch; rice starch; bean starch; legume starch; pea starch; fruit starch; root starch; and grain starch.

12. A process of claim 12, wherein the lipid is selected from the group consisting of: fatty acids; monoglycerides; diglycerides; and phospholipids.

13. A process of claim 12, wherein the lipid is a fatty acid.

14. A process of claim 15, wherein the fatty acid is selected from the group consisting of: stearic acid; palmitic acid; myristic acid; butyric acid; oleic acid; and sodium propionate.

15. A process of claim 12, wherein the high-amylose starch has been pre-treated with a debranching enzyme, and the lipid is a fatty acid.

16. A process of claim 17, wherein the debranching enzyme is selected from the group consisting of: pullulanase and isoamylase.

17. A process of claim 17, wherein the fatty acid is approximately 2 to 20% of the high amylose starch, when dry, and referenced by weight.

18. A process of claim 21, wherein the fatty acid is approximately 5 to 10%.

19. A food composition comprising a modified resistant starch of claim 1.

20. A method to affect the physiology of a mammal, selected from the group consisting of: decreasing plasma insulin response; decreasing plasma glucose response; increasing colonic fermentation; decreasing the risk of colon cancer; increasing digestive health; decreasing colonic pH, comprising administering a food composition of claim 1.
